(19) United States
(12) Patent Application Publication
(10) Pub. No.: US 2011/0214756 A1
(43) Pub. Date: Sep. 8, 2011

(54) Servo Valve

(76) Inventor: Markus Lingemann, Bochum (DE)

(21) Appl. No.: 13/061,607

(22) PCT Filed: Sep. 3, 2009
(86) PCT No.: PCT/EP09/07224

§ 371 Date: May 25, 2011

(30) Foreign Application Priority Data
Sep. 3, 2008 (DE) 10 2008 045 537.7

(51) Int. Cl. F16K 31/00

(52) U.S. Cl. 137/485

(57) ABSTRACT

The invention relates to a servo valve for a hydraulic vehicle steering system, having a valve sleeve and an input shaft which is arranged within the valve sleeve and can be rotated relative to the valve sleeve about a common axis, the valve sleeve and the input shaft each having axially oriented control grooves positioned at least partially opposite each other, each control groove of the valve sleeve and of the input shaft being connected with two adjacent control grooves of the input shaft and of the valve sleeve, respectively, via a respective control gap, a first control gap being formed between a pressure port and a working port of the servo valve associated with the pressure port, and a second control gap being formed between a return port associated with the pressure port and the working port of the servo valve, the second control gap having a smaller flow cross-section than the first control gap in a center position of the valve.

### CROSS-REFERENCE TO RELATED APPLICATIONS

This application is a national stage of International Application No. PCT/EP2009/007224 filed Sep. 3, 2009, the disclosures of which are incorporated herein by reference in entirety, and which claimed priority to German Patent Application No. 10 2008 045 537.7 filed Sep. 3, 2008, the disclosures of which are incorporated herein by reference in entirety.

### BACKGROUND OF THE INVENTION

The present invention relates to a servo valve for a hydraulic vehicle steering system.

Servo valves are known from the prior art and are typically installed in hydraulic power steering systems of vehicles to provide a hydraulic assist force for the steering movements of a driver of a vehicle. Any unevennesses in the road surface may have an effect on the chassis and therefore on the vehicle steering and may be perceived by the vehicle driver at the steering wheel as an undesirable “bumpiness of the steering”. Owing to a more direct dimensioning of the chassis and a rigid coupling between the steering gear and the chassis, the bumpiness of the steering is more strongly perceivable in power steering systems used today. In addition, energy-saving pumps are increasingly made use of in the power steering systems to reduce the energy demand. In particular when driving straight ahead, the volume flow rate of such pumps and thus also the system pressure of the power steering system are reduced. As the system pressure decreases, the pressure-dependent equivalent bulk modulus E′ₒᵢₗ and therefore the system rigidity, which has a damping effect on the bumpiness, are also reduced. Therefore, any bumpiness in the steering occurring when driving straight ahead (i.e. in a center position of the servo valve) is especially distinctly perceptible at the steering wheel.

The bumpiness appearing needs to be dampened mechanically or hydraulically. A so-called 9-land servo valve serving this purpose is disclosed in the prior art which, upon a rotation of the valve, i.e. in a cornering of the vehicle, generates a dynamic pressure on the low pressure side, and thus dampens the bumpiness in the steering wheel.

DE 100 2006 056 350 A1 discloses a valve design, in particular for such a 9-land servo valve, in which a dynamic pressure is generated on the low pressure side and therefore the bumpiness in the steering wheel is dampened even in a center position of the valve, i.e. when the vehicle travels straight ahead.

### BRIEF SUMMARY OF THE INVENTION

It is a feature of the invention to provide a servo valve for vehicle steering systems in which any bumpiness occurring in the steering wheel, in particular when driving straight, is dampened even better in as simple a manner as possible and essentially irrespective of the type of valve.

In accordance with the invention, the feature is achieved by a servo valve for a hydraulic vehicle steering system, including a valve sleeve and an input shaft which is arranged within the valve sleeve and can be rotated relative to the valve sleeve about a common axis, the valve sleeve and the input shaft each having axially oriented control grooves positioned at least partially opposite each other, a first control gap being formed between a pressure port and a working port of the servo valve associated with the pressure port, and a second control gap being formed between a return port associated with the pressure port and the working port of the servo valve, the second control gap having a smaller flow cross-section than the first control gap in a center position of the valve.

The second control gap thereby acts as a hydraulic throttle in the center position of the servo valve and thus hinders the return of hydraulic fluid to a reservoir. As a consequence, a dynamic pressure builds up on the low pressure side of the servo valve, this pressure, in turn, contributing to an improved damping of the bumpiness. Furthermore, there also appears an advantageous effect in the restoring characteristic of the vehicle steering system. A typical, so-called caster of a vehicle wheel causes the steering system to be acted upon towards traveling straight ahead and to be restored by means of external driving forces. Owing to the damping of this restoring force present in the center position of the valve, an undesirable “overshoot” of the vehicle steering system beyond the straight-ahead travel thereof in the restoring motion by means of external driving forces is now prevented from occurring.

In a preferred embodiment of the servo valve, a flow cross-section of the control gaps is respectively defined by a gap length and a gap width, the gap width of the second control gap being smaller than the gap width of the first control gap in the center position of the valve. These different gap widths may be made use of for adjusting a desired flow cross-section in a simple way.

Particularly preferably, in the center position of the valve the gap width of the second control gap extends substantially in the radial direction. In the region of the valve center position, i.e. for example upon a rotation of the valve of less than 0.5° about the center position, this second control gap formed as a radial gap only shows a small change in the flow cross-section, which in turn results in an especially constant damping in this region. Any manufacturing tolerances arising in the production of the grooves also only have a very small influence on the flow cross-section of the second control gap in the region of the valve center position and, in addition, may be further minimized by a simple finishing step such as, e.g., polishing of the groove flanks.

Preferably, exactly two control gaps are provided between a pressure port and an associated return port of the servo valve. The desired damping effect can thus be achieved even with commonly used 6-land servo valves having three hydraulic bridges as well as 8-land servo valves having four hydraulic bridges.

In particular, a control groove that is in direct communication with a working port of the servo valve may, together with its two adjacent control grooves, form the first control gap and the second control gap, respectively.

In a further embodiment of the servo valve, a gap length of a respective control gap extends substantially in the axial direction, i.e. substantially parallel to the longitudinal axis of the servo valve. The gap width may extend substantially perpendicularly to the longitudinal axis of the servo valve.

Preferably, the gap width of the first and/or second control gap is substantially constant over the gap length. This, for one thing, minimizes the manufacturing expenditure in producing the control grooves in the valve sleeve and the input shaft and, for another thing, allows a simple calculation and precise adjustment of the flow cross-section.

In particular, all control gaps may have substantially the same gap length, so as to further reduce the manufacturing expenditure and the costs associated therewith.

In a further embodiment of the servo valve, the gap width of the first control gap changes faster than the gap width of the second control gap when the valve is rotated in the region of the valve center position. This means that on rotating the valve in the region of the valve center position, there is a greater increase or decrease in the gap width of the first control gap than in the gap width of the second control gap. As a result, a noticeable flow control already occurs on the high pressure side of the servo valve while barely a change occurs in the flow on the low pressure side. In the final analysis, the damping thus remains almost at a constant level.

The control grooves are particularly preferably manufactured such that the gap width of the second control gap remains substantially constant when the valve is rotated in the region of the valve center position.

In a further embodiment of the servo valve, the gap width of the first control gap and the gap width of the second control gap are substantially identical as from a predefined angle of rotation of the servo valve. This results in an advantageous, even volume flow distribution inside the servo valve as from the predefined angle of rotation.

In a further embodiment, in the valve center position the flow cross-section of the second control gap is defined substantially by polished portions in the region of groove flanks of the input shaft and/or of the valve sleeve. Therefore, the flow cross-section of the second control gap can be precisely adjusted and, if required, reworked with little effort involved.

In a further embodiment, each control groove of the valve sleeve and of the input shaft communicates with two adjacent control grooves of the input shaft and of the valve sleeve, respectively, via one control gap each, preferably via exactly one control gap each. This type of design allows the valve to be manufactured particularly simply and cost-effectively.

More particularly, this control gap may be a first control gap or a second control gap. This means that all control grooves of the servo valve that are adjacent to each other communicate with one another either via a first control gap or via a second control gap. This also contributes to a simple and cost-effective valve manufacture.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a schematic longitudinal section taken through a servo valve according to the invention;

FIG. 2 shows a schematic cross-section taken through the servo valve according to FIG. 1;

FIG. 3 shows the schematic illustration of a hydraulic bridge of the servo valve according to FIG. 2;

FIG. 4 shows an area D1 of FIG. 2 on an enlarged scale to illustrate a first control gap;

FIG. 5 shows an area D2 of FIG. 2 on an enlarged scale to illustrate a second control gap;

FIG. 6 shows a graph in which a flow cross-section of the control gaps is plotted against an angle of rotation of the servo valve according to the invention;

FIG. 7 shows a graph for a hydraulic vehicle steering system in which a pressure in the working chambers of a hydraulic cylinder is plotted against a steering torque;

FIG. 8 shows a graph for a hydraulic vehicle steering system in which a pressure differential in the working chambers of a hydraulic cylinder is plotted against a steering torque; and

FIG. 9 shows a graph for a hydraulic vehicle steering system in which an outer toothed rack force is plotted against a toothed rack velocity.

### DETAILED DESCRIPTION OF THE INVENTION

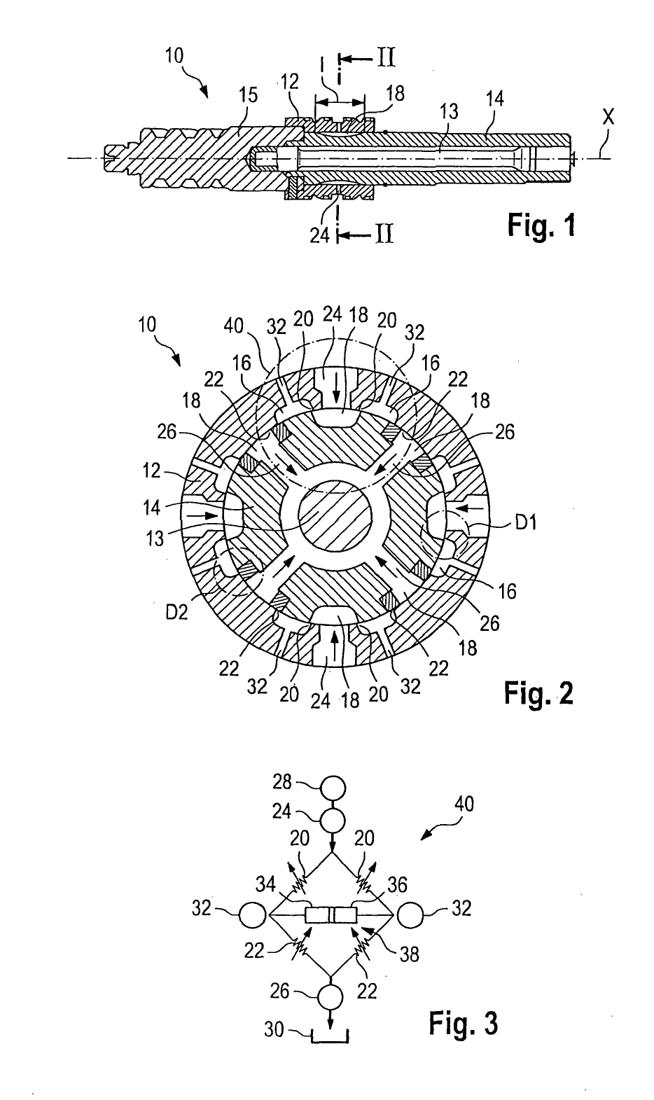

FIG. 1 schematically shows a longitudinal section taken through a servo valve 10 which includes a valve sleeve 12 and an input shaft 14, the input shaft 14 being arranged within the valve sleeve 12 and being rotatable relative to the valve sleeve 12 about a common axis X. A torsion bar 13 can be further seen, which couples the input shaft 14 to an output shaft 15 in a known manner, the output shaft 15 for its part being connected axially non-displaceably to the valve sleeve 12 for joint rotation therewith. The valve sleeve 12 and the input shaft 14 each have axially oriented control grooves 16, 18, with a control groove 16, 18 of the valve sleeve 12 and of the input shaft 14 communicating with two adjacent control grooves 18, 16 of the input shaft 14 and the valve sleeve 12, respectively, via exactly one control gap 20, 22 each (FIG. 2). The communication via exactly one control gap 20, 22 forms exactly one closed flow cross-section A₁, A₂ between two adjacent control grooves 16, 18, which continuously changes upon rotation of the valve. In particular, any complicated manufacturing processes such as groove edge gradations in the longitudinal direction of the gap, groove webs for gap interruption or the like are not necessary.

The flow cross-section A₁, A₂ of a control gap 20, 22 is each defined by a gap length 1 (cf. FIG. 1) and a gap width b₁, b₂ (cf. FIGS. 4 and 5). The gap length 1 extends substantially in the axial direction here, and the gap width b₁, b₂ extends perpendicularly to the gap length 1. In addition, in the present exemplary embodiment the gap width b₁, b₂ of the first and/or second control gaps 20, 22 is substantially constant over the gap length 1. The flow cross-section of a control gap 20, 22 thus results as a product of the axial gap length 1 and the gap width b₁, b₂ perpendicular thereto. In the connection region between a control groove 16 of the valve sleeve 12 and a control groove 18 of the input shaft 14, the gap width b₁, b₂ is each defined as the smallest distance between the valve sleeve 12 and the input shaft 14; in alternative embodiment variants, this distance can also change over the gap length 1.

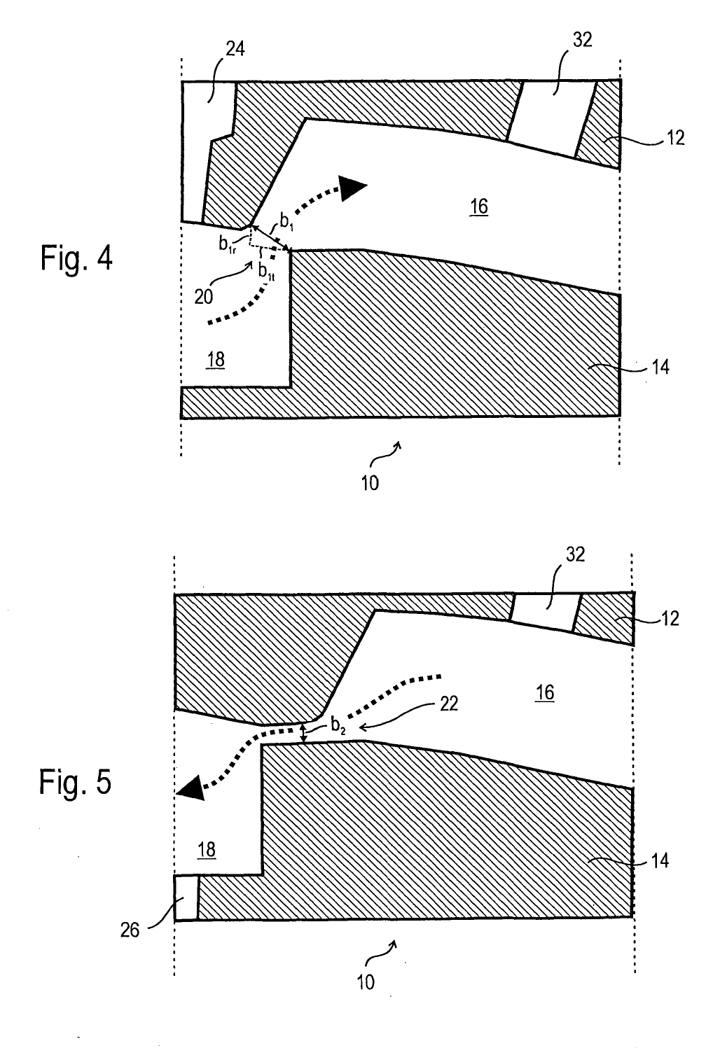

FIG. 2 shows a cross-section II-II taken through the servo valve 10 according to FIG. 1 in a center position of the valve. It can be seen here that in the present case a so-called 8-land servo valve 10 is involved, having eight control grooves 16, 18 each in the valve sleeve 12 and in the input shaft 14. The servo valve 10 has four pressure ports 24 in its valve sleeve 12 and four return ports 26 in its input shaft 14. The pressure ports 24 are connected with a hydraulic pump 28 (cf. FIG. 3) of the hydraulic vehicle steering system and are each positioned opposite a control groove 18 of the input shaft 14. The return ports 26 are connected with a reservoir 30 (cf. FIG. 3) of the hydraulic vehicle steering system and are each disposed in a control groove 18 of the input shaft 14. The servo valve 10 further comprises working ports 32 which open into control grooves 16 of the valve sleeve 12 and are connected with working chambers 34, 36 of a hydraulic cylinder 38 (cf. FIG. 3). The hydraulic cylinder 38 is coupled to a toothed rack of the vehicle steering system (not shown) and provides a hydraulic steering force by means of a pressure differential between the two working chambers 34, 36. In the exemplary valve configuration according to FIG. 2, each control groove 16 of the valve sleeve 12 includes one working port 32.

FIG. 3 schematically shows one of four identical hydraulic bridges 40 that are formed in the servo valve 10 according to FIG. 2. The relationships between the different ports 24, 26, 32 and the control gaps 20, 22 are shown illustratively here, the control gaps 20, 22 being drawn in as variable flow resistances between the individual ports 24, 26, 32.

Since the fundamental mode of operation of a servo valve 10 having a structure of this type is known from the prior art, it will not be discussed in more detail below.

The mode of operation of the servo valve 10 according to the invention will now be explained in detail below with reference to FIGS. 2 to 5.

Generally, a respective first control gap 20 is each formed between the pressure port 24 and the two circumferentially neighboring, associated working ports 32 of the servo valve 10. Formed between the two working ports 32 and their circumferentially neighboring, associated return ports 26 of the servo valve 10 is a respective second control gap 22 each. Specifically, the control gaps 20, 22 are, of course, formed by the control grooves 16, 18, which directly communicate with the respective ports 24, 26, 32. Control grooves 16, 18 are considered to be in direct communication with ports 24, 26, 32 if the respective port 24, 26, 32 is formed directly in the control groove 16, 18 or is disposed opposite the control groove 16, 18.

In the exemplary embodiment according to FIG. 2, a first control gap 20 is formed between a respective control groove 18 of the input shaft 14 which is in fluid communication with the pressure port 24 and a respective control groove 16 of the valve sleeve 12 which is adjacent to a circumferentially neighboring working port 32. A second control gap 22 is formed between a respective control groove 16 of the valve sleeve 12 which is adjacent to a working port 32 and a respective control groove 18 of the input shaft 14 which is adjacent to a circumferentially neighboring return port 26.

According to the illustration of FIG. 2, each control groove 16 in the valve sleeve 12, which directly, i.e. without a control gap 20, 22 interposed, communicates with a working port 32 of the servo valve 10, together with its two adjacent control grooves 18 in the input shaft 14, forms a first control gap 20 and a second control gap 22 each, the gap width b₂ of the second control gap 22 being smaller than the gap width b₁ of the first control gap 20 in a center position of the valve (cf. FIGS. 4 and 5). In this connection, a valve position in which the valve sleeve 12 is in a hydraulic center position relative to the input shaft 14 is referred to as center position of the valve, this valve position having an angle of rotation a of the servo valve 10 of a =0° assigned to it. In the center position of the valve, the flow resistances of the servo valve 10 in the inflow and the return flow of the working chambers 34, 36 are equal, so that identical pressures will develop in the working chambers 34, 36 and no hydraulic steering force is generated. As a rule, the valve center position of the servo valve 10 corresponds to a straight-ahead travel of the vehicle.

To illustrate the difference between the first control gaps 20 and the second control gaps 22 more clearly, a detail D1 of FIG. 2 is shown in FIG. 4 and a detail D2 in FIG. 5, the servo valve 10 being in its valve center position in each case.

The control groove 16, shown in FIG. 4, of the valve sleeve 12 includes a working port 32 and communicates with the control groove 18 of the input shaft 14 via a first control gap 20, the control groove 18 of the input shaft 14 being associated with a pressure port 24. The first control gap 20 has a gap length 1 perpendicularly to the plane of projection and the gap width b₁ drawn in in FIG. 4. The gap width b₁ is decisively determined by a circumferential or tangential component b₁, here, but a radial component b₁ᵣ can also influence the gap width b₁. In any case, the gap width b₁ is defined as the smallest distance between the valve sleeve 12 and the input shaft 14 in the connection region of the control grooves 16, 18, so that a flow cross-section Aₗ of the first control gap 20 results based on the gap length 1 and the gap width b₁.

The control groove 16, shown in FIG. 5, of the valve sleeve 12 includes a working port 32 and communicates with the control groove 18 of the input shaft 14 via a second control gap 22, the control groove 18 of the input shaft 14 having a return port 26. The gap definitions set up above for the first control gap 20 apply analogously to the second control gap 22 as well. Compared with the first control gap 20 according to FIG. 4, it will be appreciated that the gap width b₂ of the second control gap 22 according to FIG. 5 is smaller than the gap width b₁ of the first control gap 20. Due to the small gap width b₂ between the working ports 32 and the respectively associated return ports 26, the second control gaps 22 act as a throttle. In the center position of the valve, a predefinable dynamic pressure will therefore develop in the working chambers 34, 36 of the hydraulic cylinder 38, which results in a desired damping in the vehicle steering system. In an embodiment variant of the servo valve 10, the gap width b₂ of the second control gap 22 is, at most, half as large as the gap width b₁ of the first control gap 20 in the center position of the valve.

In comparison with the first control gap 20 according to FIG. 4, it can be noted in respect of the second control gap 22 (FIG. 5) that its gap width b₂ extends substantially in the radial direction in the center position of the valve, so that b₂ z b₂, applies.

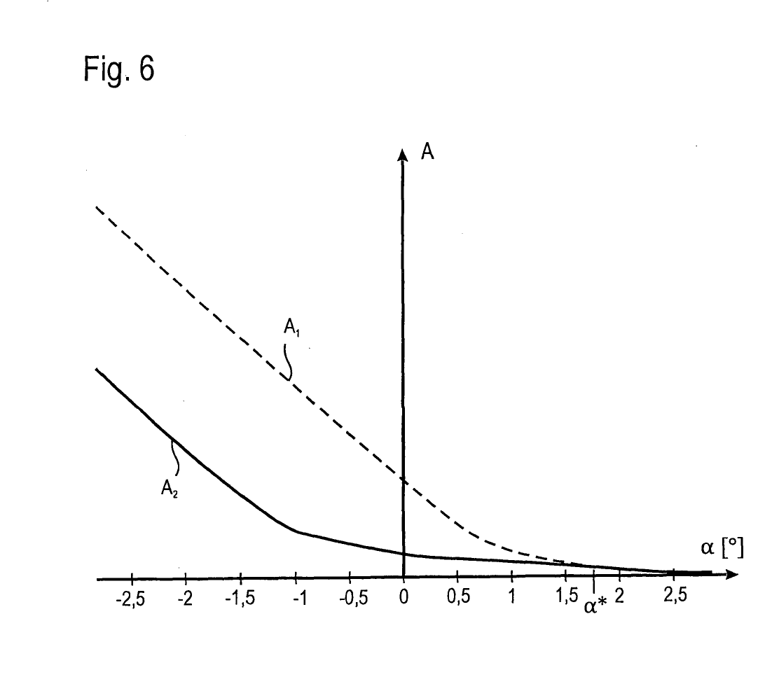

FIG. 6 shows a graph in which the flow cross-sections A₁, A₂ of a first control gap 22 (dashed curve) and of a second control gap 22 (continuous curve) are plotted against the angle of rotation a of the servo valve 10.

Since in the present exemplary configuration the gap length 1 of all control gaps 20, 22 is substantially equal, the difference in the flow cross-sections A₁, A₂ in the valve center position (α=0°) results from the difference in the gaps widths b₁, b₂ of the first and second control gaps 20, 22.

In the region of the valve center position, that is, for example, for −0.5°<α<0.5°, the gap width b₁ of the first control gaps 20 changes faster than the gap width b₂ of the second control gaps 22. This becomes clear with reference to the different curve gradients at α≈0° and results from the different gap orientations of the first and second control gaps 20, 22. In fact, while upon a rotation of the valve the gap width b₁ of the first control gap 20 changes rapidly owing to the circumferential or tangential component b₁, b₁ᵣ, the gap width b₂ of the radially oriented, second control gap 22 remains almost constant.

In a preferred valve design the control grooves 16, 18 are therefore made such that the gap width b₂ of the second control gaps 22 remains substantially constant when the valve is rotated in the region of the valve center position.

Furthermore, the gap geometry is preferably made such that the gap widths b₁ of the first control gaps 20 and the gap widths b₂ of the second control gaps 22 are identical as from a predefined angle of rotation α* of the servo valve 10. According to FIG. 6, this predefined angle of rotation α* amounts to roughly 1.75° as an example. As a result of this gap geometry, an even, advantageous volume flow distribution will arise in the servo valve 10 in the case of angles of rotation a that are larger than the predefined angle of rotation α*.

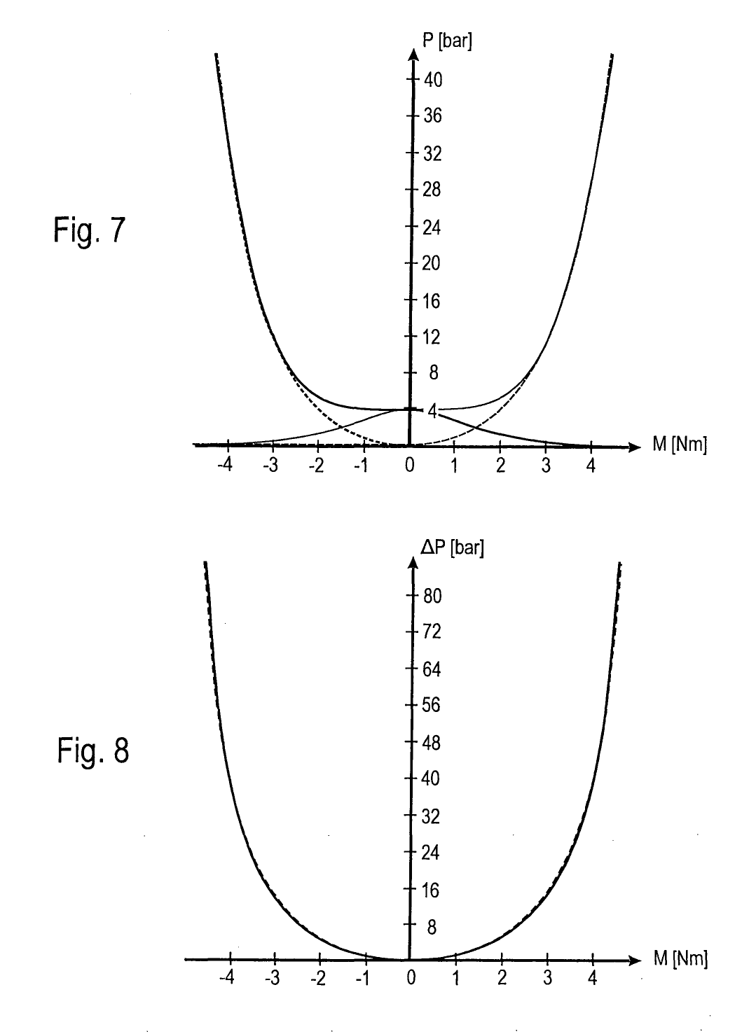

FIG. 7 shows a graph in which a pressure P in the working chambers 34, 36 is plotted against a steering torque M for a conventional servo valve (dashed curve) and a servo valve 10 according to the invention (continuous curve). As apparent from FIG. 7, for the servo valve 10 according to the invention a dynamic pressure of 4 bar was set by way of example in the valve center position (α=0°) to increase the damping in the hydraulic vehicle steering system.

FIG. 8 shows a graph in which a pressure differential AP between the working chambers 34, 36 is plotted against the steering torque M, likewise for a conventional servo valve (dashed curve) and a servo valve 10 according to the invention (continuous curve). Here, the curves for the conventional servo valve and for the servo valve 10 according to the invention are largely identical and are hard to distinguish in FIG. 8.

A comparison of FIGS. 7 and 8 shows that while a different absolute pressure P arises in the working chambers 34, 36 in the servo valve 10 according to the invention to achieve the desired damping, the hydraulic steering force resulting from the pressure differential ΔP and, hence, the behavior of the hydraulic vehicle steering system remain largely unchanged in an advantageous fashion.

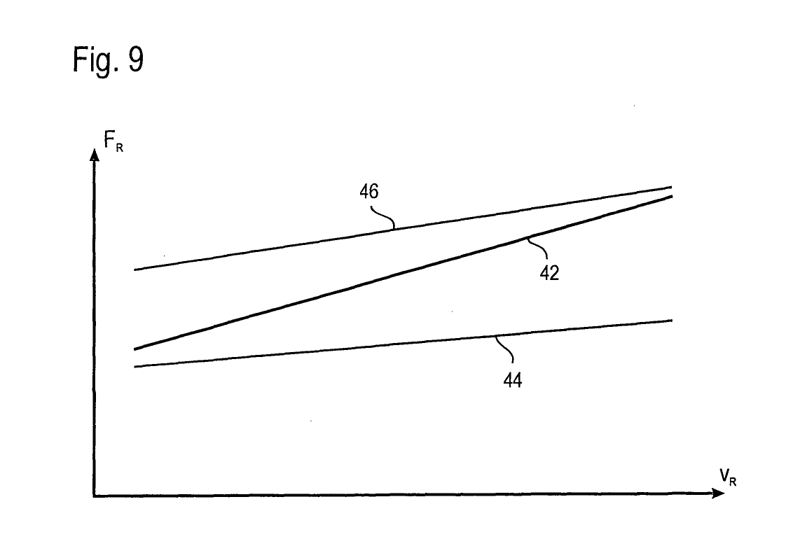

The graph in FIG. 9 represents a restoring characteristic for different vehicle steering systems, an external toothed rack force F_{R} being plotted against a toothed rack velocity v_{R} in each case. Owing to the caster of a vehicle wheel, the toothed rack is moved towards a straight-ahead travel as the toothed rack velocity v_{R} increases with increasing vehicle velocity. It is of particular advantage if the force F_{R} for moving the toothed rack is rather small at a low toothed rack velocity v_{R} and comparatively high at a high toothed rack velocity v_{R}. When the wheels are restored by means of external driving forces, this prevents, e.g., an undesirable “overshooting” of the vehicle steering system beyond the straight-ahead travel. This preferred characteristic of the vehicle steering system is particularly distinctly apparent in a curve 42 of FIG. 9, which materializes when the servo valve 10 according to FIGS. 1 to 5 is used. Additionally drawn in for a comparison are a curve 44, in which the toothed rack force F_{R} is undesirably low in the range of high toothed rack velocities v_{R}, and a curve 46, in which the toothed rack force F_{R} is undesirably high in the range of low toothed rack velocities v_{R}. The curve 44 here is associated with a vehicle steering system having a conventional servo valve without a damping in the valve center position, and the curve 46 is associated with a vehicle steering system having a conventional servo valve and separate damping valves in the servo valve return flow.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A servo valve for a hydraulic vehicle steering system, comprising
a valve sleeve and
an input shaft which is arranged within the valve sleeve and can be rotated relative to the valve sleeve about a common axis,
the valve sleeve and the input shaft each having axially oriented control grooves positioned at least partially opposite each other,
a first control gap being formed between a pressure port and a working port of the servo valve associated with the pressure port, and a second control gap being formed between a return port associated with the pressure port and the working port of the servo valve,
the second control gap having a smaller flow cross-section than the first control gap in a center position of the valve.

2. The servo valve according to claim 1, wherein a flow cross-section of the control gaps is respectively defined by a gap length and a gap width, the gap width of the second control gap being smaller than the gap width of the first control gap in the center position of the valve.

3. The servo valve according to claim 2, wherein in the center position of the valve, the gap width of the second control gap extends substantially in the radial direction.

4. The servo valve according to claim 1, wherein between a pressure port and an associated return port, exactly two control gaps are provided which are comprised of a first control gap and a second control gap.

5. The servo valve according to claim 1, wherein a control groove directly connected with a working port of the servo valve, together with its two adjacent control grooves forms the first control gap and the second control gap, respectively.

6. The servo valve according to claim 1, wherein a gap length of a respective control gap extends substantially parallel to the axis of the servo valve, and a gap width extends substantially perpendicularly to the axis of the servo valve.

7. The servo valve according to any of the preceding claim 1, wherein a gap width of the first and/or second control gap is substantially constant over a gap length.

8. The servo valve according to claim 1, wherein all control gaps have substantially the same gap length.

9. The servo valve according to claim 1, wherein a gap width of the first control gap changes faster than a gap width of the second control gap when the valve is rotated in the region of the valve center position.

10. The servo valve according to claim 1, wherein a gap width of the second control gap remains substantially constant when the valve is rotated in the region of the valve center position.

11. The servo valve according to claim 1, wherein a gap width of the first control gap and a gap width of the second control gap are substantially identical as from a predefined angle of rotation of the servo valve.

12. The servo valve according to claim 1, wherein in the valve center position, the flow cross-section of the second control gap is defined substantially by polished portions in the region of groove flanks of the input shaft and/or of the valve sleeve.

13. The servo valve according to claim 1, wherein each control groove of the valve sleeve and of the input shaft is connected with two adjacent control grooves of the input shaft and of the valve sleeve, respectively, via one control gap each.

14. The servo valve according to claim 13, wherein the control gap is a first control gap or a second control gap.
